(19) United States
(12) Patent Application Publication
(10) Pub. No.: US 2017/0016716 A1
(43) Pub. Date: Jan. 19, 2017

(54) METHOD AND APPARATUS FOR RECORDING IMAGES IN THE ALIGNING OF VEHICLES HAVING A COLOR-SELECTIVE BEAM SPLITTER

(71) Applicant: Robert Bosch GmbH, Stuttgart (DE)

(72) Inventors: Reinhold Fiess, Durbach (DE); Boris Riedel, Ubstadt-Weiher (DE)

(21) Appl. No.: 15/124,922

(22) PCT Filed: Jan. 26, 2015
(86) PCT No.: PCT/EP2015/051479

§ 371 Date: Sep. 9, 2016

(30) Foreign Application Priority Data
Mar. 13, 2014 (DE) 10 2014 204 686.6

(51) Int. Cl. G01B 11/275; H04N 5/247; G06T 7/00; H04N 17/00; H04N 9/04

(52) U.S. Cl. CPC G01B 11/2755; H04N 17/002; H04N 9/04; G06T 7/0018; G06T 7/0044; H04N 5/247; G01B 2210/143; G02B 27/1013

(57) ABSTRACT

An image-recording device for aligning vehicles has at least one camera; at least one illumination device; and at least one color-selective beam splitter that is designed to channel light from different directions into the at least one camera and/or to color-selectively direct light from the at least one illumination device into different directions. The color-selective beam splitter has at least one optical marker that is able to be captured by a camera of another image-recording device, in order to determine the position of the color-selective beam splitter in relation to the camera of the other image-recording device.

### FIELD

The present invention relates to a method and an apparatus for recording images in the aligning of vehicles.

### BACKGROUND INFORMATION

Wheel-alignment analyzers for aligning vehicles, especially for measuring camber and toe of a (motor) vehicle, usually have a plurality of light sources (infrared or colored LEDs) that illuminate marker objects mounted on the wheels, as well as a plurality of camera systems that detect the changes at the marker objects during the dynamic suspension alignment.

The systems used at present usually have one light source and one marker object per wheel, as well as a camera system that may take the form of both a mono camera system and stereo camera system. Based on the change in the spatial position of the marker objects, any deviations of the camber or toe from the ideal state are determined with the aid of image processing and thus may be rectified.

A camera system is usually provided on each side of the vehicle to be aligned, and the position of the two camera systems relative to each other is determined in a calibration step before the measurement is performed.

Because of thermal and mechanical influences, the camera systems may shift relative to each other after the calibration, thereby negatively influencing the quality of the measuring results.

### SUMMARY

An object of the present invention is to improve the quality of an image-based vehicle alignment, and especially to detect a shift of the image-recording devices relative to each other, so as to be able to correct it.

In accordance with the present invention, image-recording devices are used, each of which is implemented with a color-selective beam splitter and a (monochrome or color-coded) camera chip (image sensor), in order to simultaneously image the spatial position of the marker objects both at the front wheel and at the rear wheel on one side of a vehicle to be aligned, and which are able to determine the relative position (position referencing) with respect to a unit located on the opposite side of the vehicle, in each case at least one optically detectable marker being formed on the color-selective beam splitter, the marker making it possible to recognize changes in the position of the beam splitter, produced by thermal and mechanical influences, in relation to the camera of the unit located in each instance on the opposite side of the vehicle.

In this way, shifts of the images imaged on the image sensors, and therefore accompanying measuring errors resulting from movements of image-recording devices, may be corrected, thus ensuring high accuracy of the measuring results without the need for additional systems to detect the mirror movements.

Moreover, stringent accuracy demands placed on the mounting brackets of the mirrors may be reduced, since possible movements of the mirrors are able to be recognized and corrected.

To that end, an image-recording device according to the present invention for aligning vehicles includes at least one camera, at least one illumination device and at least one color-selective beam splitter that is designed to channel light from different directions into the at least one camera and/or to color-selectively direct light from the at least one illumination device into different directions. The color-selective beam splitter has at least one optical marker that is able to be captured by a camera of another image-recording device in order to determine the position of the color-selective beam splitter in relation to the camera of the other image-recording device.

The present invention also includes a system for aligning vehicles, having at least two image-recording devices according to the present invention and an evaluation device that makes it possible to determine the position of the image-recording devices relative to each other on the basis of the recorded images; as well as a method having the following steps:

Mounting an image-recording device according to the present invention on each side of a vehicle to be aligned;

Capturing images of the optical markers, that are applied on the beam splitters, by the camera of the respective other image-recording device; and

Determining the relative position of the two image-recording devices from the images captured.

In one specific embodiment, the beam splitter includes at least one dichroic element. A dichroic element provides an especially efficient beam splitter.

In one specific embodiment, the beam splitter is designed to color-selectively divert light from/into at least three different directions. This makes it possible to simultaneously detect objects to be measured at the front wheel and rear wheel of a vehicle (first direction “forward” and second direction “rearward”), and at the same time to determine the position of the image-recording device in relation to a further image-recording device preferably positioned on the opposite side of the vehicle (third direction).

In one specific embodiment, the illumination device includes a plurality of light sources that, in particular, emit light of different color, so that the light of the various light sources may be conducted or deflected efficiently by the color-selective beam splitter into the various directions.

The camera may have a color-selective image sensor, especially an image sensor equipped with a Bayer filter, which makes it possible to select images, recorded from the various directions, on the basis of their color.

Alternatively or additionally, the illumination device may be designed to drive the light sources in pulsed fashion and/or separately from each other, so as by selective driving of individual light sources, to permit a selection of the images recorded from the different directions, even if a monochromatic image sensor is used.

The present invention is explained in greater detail below based on an exemplary embodiment shown in the figures.

### BRIEF DESCRIPTION OF THE DRAWINGS

FIG. 1 shows a perspective view of a known apparatus for optical vehicle alignment in respect to a vehicle.

FIG. 2 shows a schematic top view of a system according to the present invention for optical vehicle alignment.

FIG. 3 shows schematically the imaging on an image sensor of one of the image-recording devices.

### DETAILED DESCRIPTION OF EXAMPLE EMBODIMENTS

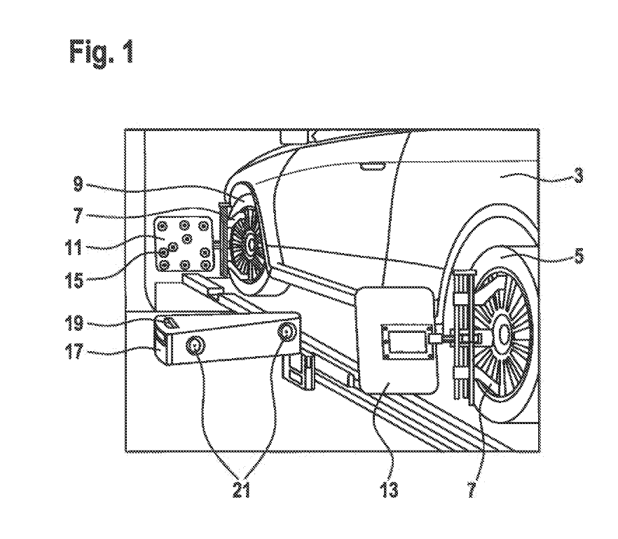

FIG. 1 shows a perspective view of a conventional apparatus for optical vehicle alignment in respect to a vehicle 3. What are referred to as measuring targets (paddles) 11, 13 are mounted as target objects on wheels 5, 9 of a motor vehicle 3 with the aid of wheel adapters 7. Measuring targets 11, 13 each have a generally plane surface that is aligned transversely to the longitudinal extension of motor vehicle 3 and on which one or more optically recordable, especially reflective markers (measuring marks) 15 are formed.

The apparatus also includes two image-recording devices 17, one on each side of motor vehicle 3, of which only one is shown in FIG. 1. Each of image-recording devices 17 has four measuring cameras 21 (of which only two are visible in FIG. 1) and a referencing device 19, as well as an evaluation unit, not shown in FIG. 1, that includes at least one processing and storage unit designed, among other things, to execute an image-processing software in order to evaluate the images recorded by measuring cameras 21.

In each case two measuring cameras 21 placed side by side form a stereo camera system that in each instance is aligned with one of measuring targets 11, 13, and records images of markers 15 formed on measuring targets 11, 13. In total, the wheel-alignment analyzer shown in FIG. 1 includes four cameras 21 on each side of vehicle 3.

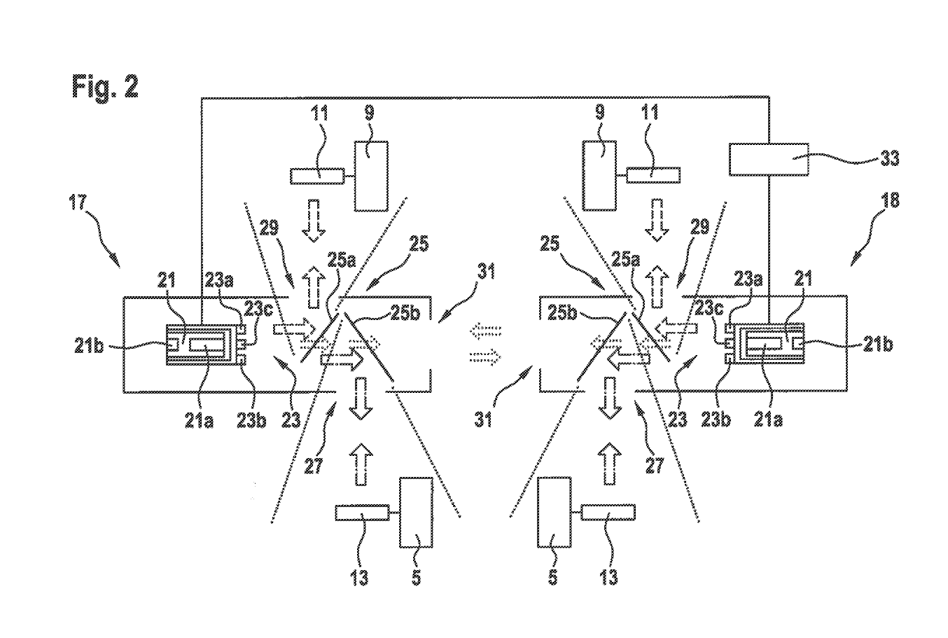

FIG. 2 shows a schematic top view of a system according to the present invention having two image-recording devices 17, 18 that are disposed laterally on both sides of a vehicle 3 to be aligned (not shown in FIG. 2), and are connected electrically to one common evaluation and control device 33.

Image-recording devices 17, 18 each have a camera 21 having a lens 21a and a color-sensitive image sensor 21b that is formed with a Bayer filter, for instance.

Situated around each lens 21a is a plurality of light sources 23a, 23b, 23c which during operation, emit light of different wavelength/color, e.g., red, green and blue. In FIG. 2, blue light is represented by dashed-line arrows, green light by dotted-line arrows and red light by arrows made of dash-dot lines.

For example, light sources 23a, 23b, 23c may take the form of colored LEDs or other light sources that are furnished with a suitable color filter.

Situated in each case in front of lens 21a and light sources 23a, 23b, 23c is a beam splitter 25 that, in the exemplary embodiment shown, includes two dichroic mirrors 25a, 25b which reflect or transmit incident light in color-selective fashion.

In the exemplary embodiment shown, in particular blue light (dashed-line arrows), which is emitted by a first light source 23a, is diverted through a first opening 29, formed in the housing of image-recording device 17, 18, in the direction of measuring target 11 mounted on front wheel 9 of vehicle 3. In the same way, blue light reflected by measuring target 11 mounted on front wheel 9 of vehicle 3 is diverted into lens 21a.

Red light (dash-dot arrow), which was emitted by a second light source 23b, is diverted through a second opening 27, formed in the housing of image-recording device 17, 18, in the direction of measuring target 13 mounted on rear wheel 5 of vehicle 3. In the same way, red light reflected by measuring target 13 mounted on rear wheel 5 of vehicle 3 is diverted into lens 21a.

Green light (dotted-line arrows), which is emitted by a third light source 23c, is not deviated by beam splitter 25 and radiates through a third opening 31, formed in the housing of image-recording device 17, in the direction of second image-recording device 18 that is situated opposite on the other side of vehicle 3. Similarly, green light emitted by second image-recording device 18, disposed on the other side of vehicle 3, impinges on lens 21a of first image-recording device 17, without being deviated by one of beam splitters 25. This permits a mutual referencing of the two image-recording devices 17, 18 situated opposite each other.

The assignment of the colors to front and rear measuring targets 11, 13 and opposite image-recording device 17, 18 described is only by way of example. The colors may also be exchanged for one another in their assignment and function, and different colors or color combinations may be used, as well, for which suitable light sources 23a, 23b, 23c and beam splitters 25 are available.

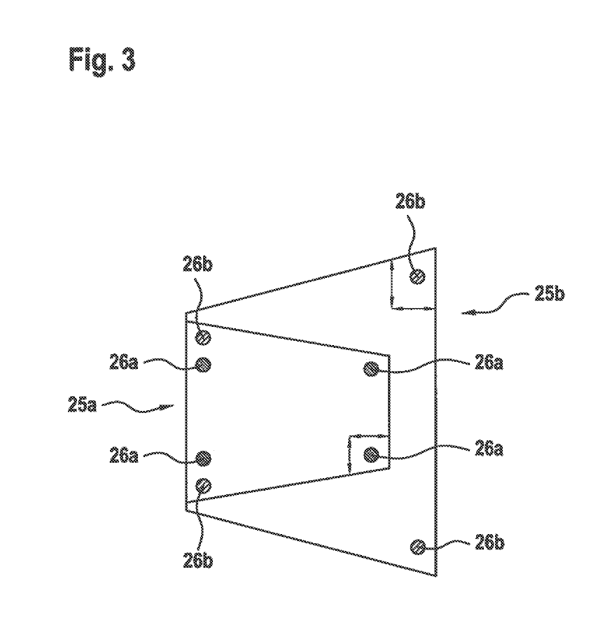

FIG. 3 shows schematically the imaging of the two mirrors 25a, 25b with their markers 26a, 26b from the view of camera 21 of opposite image-recording device 17. By recognizing changes in the positions of markers 26a, 26b in the images recorded, movements of mirrors 25a, 25b in relation to camera 21, which may have mechanical and/or thermal causes, for example, may be detected and corrected, so as to be able to ensure high quality and, above all, accuracy of the measuring results even after a relative movement of the two image-recording devices 17, 18.

1-10. (canceled)

11. An image-recording device for aligning vehicles, comprising:
at least one camera;
at least one illumination device; and
at least one color-selective beam splitter which is designed to at least one of: channel light from different directions into the at least one camera, and color-selectively direct light from the at least one illumination device into different directions;
wherein the color-selective beam splitter has at least one optical marker that is able to be captured by a camera of another image-recording device to determine the position of the color-selective beam splitter in relation to the camera of the other image-recording device.

12. The image-recording device as recited in claim 11,
wherein the beam splitter includes at least one dichroic element.

13. The image-recording device as recited in claim 11, wherein the beam splitter is designed to color-selectively divert light from or into at least three different directions.

14. The image-recording device as recited in claim 11, wherein the illumination device includes a plurality of light sources including a plurality of light sources that emit light of different color.

15. The image-recording device as recited in claim 14, wherein the illumination device s designed to drive the light sources at least one of: i) in pulsed fashion, and ii) separately from each other.

16. The image-recording device as recited in claim 11, wherein the camera includes a color-selective image sensor, the image sensor being equipped with a Bayer filter.

17. A system for aligning vehicles, comprising:
at least two image-recording devices, each of the image-recording devices including at least one camera, at least one illumination device, and at least one color-selective beam splitter which is designed to at least one of: channel light from different directions into the at least one camera, and color-selectively direct light from the at least one illumination device into different directions, wherein the color-selective beam splitter has at least one optical marker that is able to be captured by a camera of another image-recording device to determine the position of the color-selective beam splitter in relation to the camera of the other image-recording device.

18. The system for aligning vehicles as recited in claim 17, further comprising:
at least one evaluation device which is designed to evaluate the images captured by the cameras of the image-recording devices to determine the relative position of the image-recording devices.

19. A method for recording images in the aligning of vehicles, the method comprising:
mounting one image-recording device on each side of a vehicle to be aligned, the image-recording devices each including at least one camera, at least one illumination device, and at least one color-selective beam splitter which is designed to at least one of: channel light from different directions into the at least one camera, and color-selectively direct light from the at least one illumination device into different directions, wherein the color-selective beam splitter has at least one optical marker that is able to be captured by a camera of another image-recording device to determine the position of the color-selective beam splitter in relation to the camera of the other image-recording device;
capturing images of the optical markers, which are applied on the beam splitters, by the camera of the respective other image-recording device; and
determining a relative position of the two image-recording devices from the images captured.

20. The method as recited in claim 19, further comprising:
driving the light sources in at least one of pulsed fashion and separately from each other.
